(19) United States
(12) Patent Application Publication
(10) Pub. No.: US 2009/0221865 A1
(43) Pub. Date: Sep. 3, 2009

(54) METHOD AND APPARATUS FOR INJECTING ENRICHED STEAM

(76) Inventor: REGIS P. RENAUD, Silverado, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/395,192

(22) Filed: Feb. 27, 2009

Related U.S. Application Data
(60) Provisional application No. 61/032,387, filed on Feb. 28, 2008.

(51) Int. Cl. A62D 3/37

(52) U.S. Cl. 588/319

(57) ABSTRACT

A method of sequestering CO₂, CO, NOₓ and/or other gases, including exhaust gases, into steam and injecting it into organic waste such as is found in landfills, biomass reactors, and the like. The steam enriched with CO₂, CO, NOₓ and/or other gases injected into the landfill or biomass reactor can accelerate the decomposition/biodegradation of organic refuse within the trash prism to increase the production of methane gas and/or CO₂.

### CROSS-REFERENCE TO RELATED APPLICATIONS AND INCORPORATION BY REFERENCE

This application claims the benefit under 35 U.S.C. §119 of U.S. provisional application No. 61/032,387, filed Feb. 28, 2008 which is hereby incorporated by reference in its entirety. This application also hereby incorporates by reference in its entirety U.S. Pat. No. 6,471,443, issued Oct. 29, 2002.

### BACKGROUND OF THE INVENTION

1. Field of the Invention

Embodiments of the invention relate to methods of sequestering CO₂, CO and/or NOₓ into steam and injecting it into landfills, biomass reactors and the like. Specifically, the embodiments provide methods of injecting steam enriched with CO₂, CO, NOₓ and/or other gases, including exhaust gases, into a landfill or biomass reactor to accelerate the decomposition/biodegradation of organic refuse within the trash prism to increase the production of methane gas and/or CO₂.

2. Description of the Related Art

In general, landfills are constructed using the “dry tomb” method, in which the refuse in the landfill is kept as dry as possible both during construction and when the landfill is closed and capped. This method minimizes the possibility of leachate, or liquid that drains or ‘leaches’ from a landfill, from leaking into groundwater and contaminating it. However, dry conditions are not conducive to the decomposition of the organic refuse. Instead, the organic refuse remains dormant for decades until water infiltrates the landfill in an uncontrolled and natural manner. The water infiltration may cause gas migration, which can lead to groundwater and atmosphere contamination.

### SUMMARY OF THE INVENTION

Injecting enriched steam into landfills and reactors, which can include, for example CO₂, CO, NOₓ and/or other gases, including exhaust gases, according to embodiments of the invention, have several features, no single one of which is solely responsible for its desirable attributes. In addition, sequestering CO₂, CO, NOₓ and/or other gases, including exhaust gases, and other methods described herein, according to embodiments of the invention have several features, no single one of which is solely responsible for its desirable attributes.

Without limiting the scope, more prominent features will now be discussed briefly. The features of some embodiments of the invention provide certain advantages, which can include minimization of the amount of liquid introduced into the landfill, total moisturization and higher overall humidity of the landfill or reactor. Other benefits can include providing the above advantages without the need to apply head pressure, promotion of settlement of the landfill, thorough heating of the refuse to increase decomposition, avoidance of clogging of gas extraction collectors, the ability to distribute additional carbon in the form of CO₂ throughout the trash prism, increased methane and CO₂ production, and production of methane having higher Btu values as compared to methane produced in other landfill and/or reactor systems. In some embodiments, one goal is to heat the surface of the waste that surrounds the void spaces (about 20% by volume) in the waste prism rather than the whole waste mass. This can help keep the required Btu values manageable.

Some embodiments comprise a method of enhancing the decomposition of organic waste. The method can comprise providing steam, enriching the steam with gas and injecting enriched steam into organic material. The organic material, in some embodiments, can be in a landfill or a biomass reactor. The gas of some embodiments comprises CO₂, CO and/or NOₓ. The method can further comprise sequestering the gas into the steam to enrich it.

In certain embodiments, the method can further comprise spraying water into a chamber containing the gas and creating steam by vaporizing the water. In some embodiments, the gas can be exhaust gas. The heat of the exhaust may flash the water into steam to create enriched steam. In some embodiments, waste steam can be mixed with exhaust gases to enrich the steam with CO₂, CO and/or NOₓ. The enriched steam can be conveyed to the landfill or biomass reactor by negative pressure. In the different embodiments, the gas can be from different sources including industrial processes related to or unrelated to a landfill or biomass reactor.

Some embodiments include a method of enhancing the decomposition of organic waste. The method can comprise injecting steam enriched by CO₂ and CO into waste, the waste comprising organic refuse, heating the waste, monitoring conditions within the waste and extracting methane gas from the waste. The step of heating the waste can be heating the waste with the steam or heating the waste through other processes. The methane can also be used to create the steam. Also, the steam can be further enriched by NOₓ and/or other exhaust gases.

Additional embodiments can comprise a method of accelerating decomposition of organic refuse. Certain methods comprise combusting a fuel and thereby creating exhaust gas, providing steam, sequestering CO₂ from the exhaust gas into the steam to create enriched steam and injecting the enriched steam into organic refuse. The method may further comprise extracting methane gas from the organic refuse. The method can further comprise spraying water into the exhaust gas to create steam. In some embodiments, the steam can be exhaust steam. The exhaust steam can be from a source such as a power plant.

### BRIEF DESCRIPTION OF THE DRAWINGS

Certain embodiments of this invention, illustrating its features, will now be presented. Among other features, these embodiments depict a novel and non-obvious method of injecting steam, enriched with CO₂ and/or other gases into landfills or biomass reactors as shown in the accompanying drawings, which are for illustrative purposes only. These drawings include the following figures, in which like numerals indicate like parts:

FIG. 1 is a schematic top view of an apparatus for performing one embodiment of the present method;

FIG. 2 is a schematic side view of the apparatus of FIG. 1;

FIG. 3 is a schematic top view of an apparatus for performing another embodiment of the present method;

FIG. 4 is a schematic of an apparatus useful in some embodiments;

FIG. 5 is a schematic of another apparatus useful in some embodiments; and

FIG. 6 is a schematic of another apparatus useful in some embodiments.

### DETAILED DESCRIPTION OF THE PREFERRED EMBODIMENTS

As discussed above, landfills constructed using the “dry tomb” method are not conducive to the decomposition of the organic refuse. Instead, the organic refuse remains dormant for decades until water infiltrates the landfill in an uncontrolled and natural manner. The water infiltration may cause gas migration, which can lead to groundwater contamination.

The slow decomposition of the organic refuse under dry conditions also slows the settling of the landfill and hinders the production of methane gas, which is a natural by-product of anaerobic (oxygen-starved) decomposition of organic material.

Moisture accelerates decomposition of organic refuse, but does not accelerate the decomposition of the non-organic refuse. Thus, the addition of moisture to the trash prism increases the purity of methane extracted from the landfill, because the proportion of decomposing organic refuse to decomposing inorganic refuse is higher as compared to a dry trash prism. The extracted methane is thus more useful because it has a higher Btu value. If the refuse is flooded with water, however, the gas becomes bound up in the liquid and is difficult to recover. Further, introducing water into a landfill cools the refuse which can decrease decomposition, as decomposition proceeds best at a temperature around 100 to 120 degrees F. Therefore, a method of introducing moisture into a trash prism that does not flood the trash prism or cool the trash prism would be of great benefit to the landfill-management industry. The same effect occurs with a biomass reactor.

Methane is primarily known as the main component of natural gas. Methane, with the molecular formula CH₄ is the simplest alkane, meaning that of chemical compounds made up of only carbon and hydrogen, it has the most basic chemical structure with only one carbon atom and four hydrogen atoms. Methane has bond angles of 109.5 degrees. The burning of methane, in the presence of oxygen, produces carbon dioxide and water. The relative abundance of methane, as a natural resource, and its clean burning process make it a very attractive fuel.

Methane can be produced by methanogens. Methanogens are single-celled microorganisms that produce methane as a metabolic byproduct in low oxygen conditions. This process of producing methane is called biomethanation. Methanogens are common in wetlands and animals, where they produce marsh gas and the methane content of animal waste. Methanogens can also be found in other environments as well. In marine sediments, biomethanation is generally confined to where sulfates are depleted, below the top layers. In extreme conditions, such as hot springs, submarine hydrothermal vents and in the “solid” rock of the earth's crust, methanogens are also known to reside.

Methanogens are usually coccoid or rod shaped. There are over 50 described species of methanogens, which do not form a monophyletic group, although all methanogens belong to Euryarchaeota, in the taxonomy of microorganisms.

Methanogens are anaerobic, meaning they do not need oxygen to grow or survive. In fact, methanogens cannot function under aerobic conditions, though they can sustain oxygen stresses for prolonged times. An exception is Methanosarcina barkeri, which contains a superoxide dismutase (SOD) enzyme and may survive longer. Some methanogens, called hydrogenotrophic, use carbon dioxide (CO₂) as a source of carbon, and hydrogen as a reducing agent. Some of the CO₂ is reacted with the hydrogen to produce methane, which produces an electrochemical gradient across a membrane, used to generate ATP through chemiosmosis. In contrast, plants and algae use water as their reducing agent. It is known that in decomposition, the basic conversion of organic carbon, such as waste in a landfill, will convert to 50% methane and 50% CO₂ However, higher levels of methane over CO₂ levels are often indicated at landfill gas (LFG) collectors. The readings will usually indicate a mass balance such as 60% CH₄ and 40% CO₂ totaling 100% in a closed system, unless air has intruded into the gas stream, changing the ratios. The way this change in ratios can occur is that the carbon in the CO₂ is converted into methane by the methanogens.

It has been observed at landfills that if the extraction process is slowed, the level of methane increases and the level of CO₂ decreases over time. Conversely if the gas is extracted too fast, the concentration of methane will decrease to 50% and if the well is overdrawn then the methane will drop below 50% and oxygen and nitrogen will be indicated in the readings.

Therefore, it can be assumed that if the landfill gas is allowed to stay inside the landfill longer and if there is excess moisture (hydrogen), the methanogens will take the carbon from the CO₂ and convert it to methane. This whole process is water/moisture driven. Therefore injecting CO₂ enriched steam into an organic waste mass can provide the methanogens with additional carbon for methane conversion.

Biogas generally includes CO₂ and not 100% methane. As carbon is removed from a CO₂ molecule, it releases the two oxygen molecules. These oxygen molecules attach to another carbon molecule in a process called oxidation creating another CO₂ molecule so there will always be CO₂ in biogas. The benefit of this oxidation process is that another molecule of carbon is converted from the waste, converted to CO₂ and removed from the landfill or reactor.

The majority of the world's CO₂ is absorbed by the oceans and is converted into various types of food and energy for the many life forms living within it. CO₂ is readily absorbed into water which changes its condition or density and allows it to remain in a vapor phase longer. It also increases its expansion pressure. Thus steam can readily absorb CO₂ to create enriched steam. Steam can also be enriched with other gases.

Some embodiments of the present invention relate to methods of sequestering CO₂, CO, NOₓ and/or other gases, including exhaust gases, into steam and injecting it into organic and other matter such as found in landfills, biomass reactors and the like. A method of injecting steam enriched with CO₂, CO, NOₓ and/or other gases, into a landfill or biomass reactor can accelerate the decomposition/biodegradation of organic refuse within the trash prism. This can also increase the production of methane gas and CO₂.

The organic waste in a landfill, reactor or the like, can be used as a scaffold to support anaerobic microbes, which can convert organic carbon into biogas and can also convert the carbon in CO₂ and CO into additional biogas. Further, the anaerobic microbes can convert NOₓ into acid in the steam, as it does when it rains. Enriching steam with NOₓ can change the pH of the steam.

Some embodiments can increase the production of additional methane. For example, this can be done by separating the CO₂ produced in the first application of steam from the methane component of the landfill gas and then re-introducing it into the steam system. The enriched steam can then be conveyed into the landfill waste prism or reactor to be converted to methane. In some embodiments this separated CO₂ is for example, sent to algae tanks to make alternative fuels, sent to greenhouses, or made into food grade dry ice.

Exhaust can also be mixed into the steam system and returned to the landfill or reactor site. Preferably, exhaust from flares, power plants and other landfill gas (LFG) conversion processes, since it is contaminated with other volatile organic compounds (VOC), is mixed into the steam system and returned to the landfill or biomass reactor. This reduces the carbon emissions from the landfill or reactor site allowing more power plants and other LFG conversion technologies to operate at these sites without air quality restrictions. LFG typically consists of 50% methane and 50% CO₂ when organic waste decomposes naturally. With enriched steam injection, the LFG can consist of 80% methane and 20% CO₂ with an increase in volume in relation to the amount of enriched steam injected. Various embodiments of the inventions address the CO₂ portion of landfill gas and the exhaust from combustion engines and flares.

Some embodiments of the present method comprise injecting steam and CO₂ into a landfill or biomass reactor and collecting the methane produced by the decomposition/biodegradation of the organic component of the trash prism. The steam accelerates the decomposition of the organic refuse, thereby enhancing methane gas production and increasing the purity of the methane. For example, the CO₂ component of the steam can provide more carbon for the conversion process into methane. The reduced decomposition time advantageously reduces the impact of the landfill on the environment. With increased production of methane of a higher purity, what is normally waste gas can instead be converted into fuel.

The steam can be derived from a source such as a boiler, heat exchanger or waste steam from a power plant. In some embodiments of the invention, steam is produced by injecting water into the hot exhaust from flares, internal combustion engines, boilers or other gas conversion devices thereby sequestering the CO₂ into the steam stream. By spraying water into the exhaust system of the power generator or other engine on site, the water will flash into steam and capture the exhaust components into the steam. In some embodiments, this enriched steam can then be injected into the landfill or reactor through an array of steam injection wells or ports respectively. Additional CO₂ separated from the LFG and not cleaned to food grade may also be introduced to this steam stream.

### The CO₂ Sequester Process

Keeping the natural processes described above in mind, it should be possible to enhance this process by using steam injected into the waste prism. Enriching the steam stream with CO₂, CO and/or NOₓ by sequestration can also enhance the process further. The sequester can contain a chamber mounted downstream of a burner or exhaust of an internal combustion (IC) engine. The chamber of some embodiments contains spray nozzles to apply water into the chamber and into the hot exhaust of the burner or IC engine. This can cause the water to flash into steam and absorb the exhaust gases into the steam. In some embodiments, a second nozzle is located near the burner to insure that the temperature remains below 1,100° F. to prevent the water from breaking down to hydrogen and oxygen. Some embodiments may allow the temperature to exceed 1,100° F. to allow the creation of the hydrogen and oxygen to increase the Btu value of the biogas. If the methanogens do not convert the raw hydrogen into methane then it will be used as fuel as part of the biogas. In another embodiment, waste steam, instead of, or in addition to water, can be sprayed into the sequester chamber where the exhaust gases are sequestered.

In a preferred method, steam enriched with CO₂, CO and NOₓ is injected into a landfill 10. The steam promotes the anaerobic biodegradation of the organic refuse in the landfill 10, which in turn increases methane gas generation and increases the rate of settlement of the landfill 10. The carbon in the CO₂ and CO sequestered in the steam will be digested by the methanogens in the waste prism of the landfill 10 and produce additional methane and CO₂.

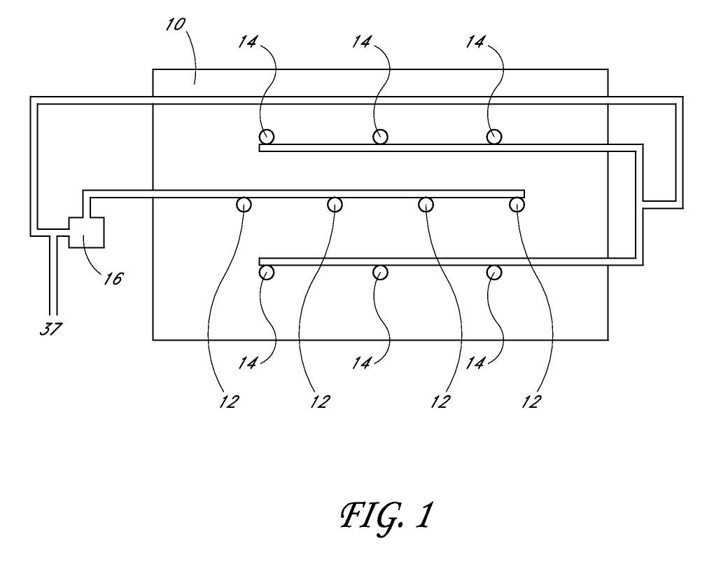

FIG. 1 schematically illustrates an apparatus for performing an embodiment of the present invention in a landfill 10. Several lines of steam and CO₂ injection wells 12 and several lines of gas extraction collectors 14 are positioned within a landfill 10. The arrangement depicted in FIG. 1 is merely exemplary. The ideal location for the injection wells 12 and gas collectors 14 is preferably determined prior to installing the steam injection apparatus, and may differ significantly from the arrangement of FIG. 1.

One method of determining the ideal location for the steam and CO₂ injection wells 12 and gas collectors 14 is to perform a piezo-penetrometer test (PPT) profile on the landfill 10. The PPT profile can be performed with a cone-shaped instrument having sensors that measure several parameters as the cone is hydraulically pushed into the landfill 10. The PPT profile provides information about the in-situ conditions of the landfill 10. A PPT rig may also be used to install the steam injection wells 12 and gas extraction collectors 14 following the PPT profiling. More information concerning PPT profiling and monitoring with PPT profiling can be found in U.S. Pat. No. 6,471,443 to Renaud, which is herein incorporated by reference in its entirety.

After installation of the steam injection wells 12 and gas extraction collectors 14, steam injection can commence through the injection wells 12. Low pressure centers are preferably created at the gas extraction collectors 14, as by attaching a header and blower system to the collectors 14, for example. The low pressure centers create currents within the trash prism that distribute the steam throughout the trash prism. Adjustment of the relative positions of the injectors 12 and collectors 14 enables the enriched steam currents to be altered in case particular areas of the trash prism are not receiving sufficient enriched steam.

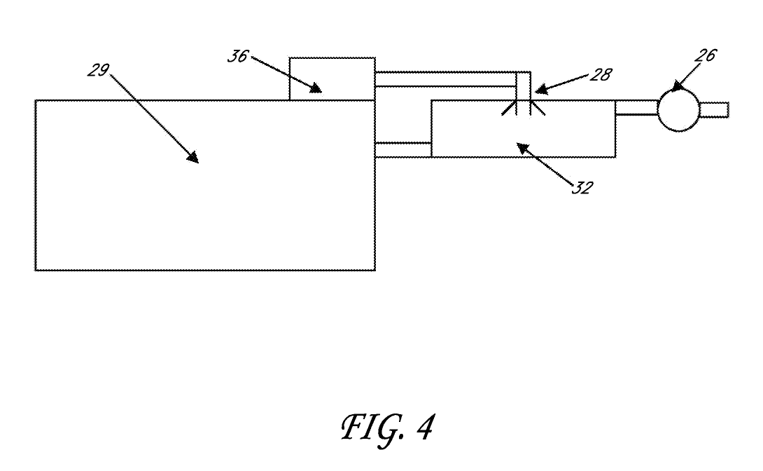

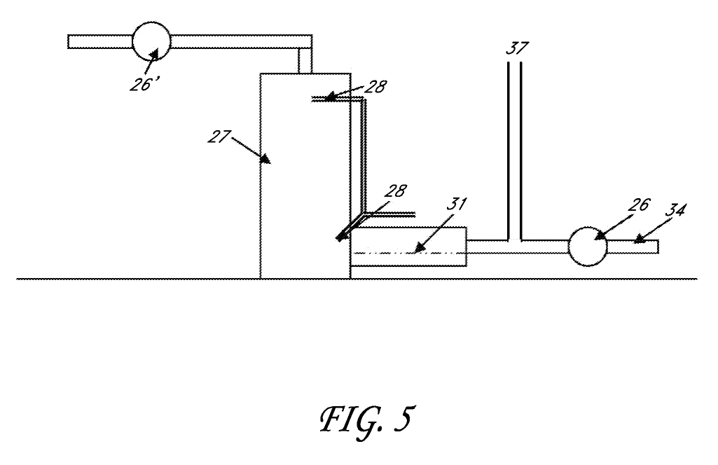

The source of steam 16 can be, for example, a gas-fired boiler, or a heat exchanger on the gas flare (see FIG. 5). Preferably, however, the source of steam 16 is exhaust steam from a power plant, which may be more economical to harness as compared to steam specially produced for the landfill 10. Different embodiments can have combinations of the steam sources or other steam sources could be used in place of the above devices or in conjunction with them. The process of steam generation of another preferred embodiment is to make steam by injecting water into the exhaust stream of flares or IC engines for generators sequestering the CO₂, CO and/or NOₓ into the steam stream (see FIGS. 4 & 5). Additional CO₂ separated from the landfill gas can also be introduced to this steam stream or the steam stream of other embodiments.

The steam enriched with CO₂, CO and/or NOₓ can then be injected into the landfill 10, raising the moisture content and the level of carbon in the landfill 10. Moisture promotes the rapid decomposition of the organic portion of the trash prism, while at the same time raising the amount of methane gas produced during decomposition. The rapid decomposition of the organic refuse causes the rapid settling of the landfill 10, which shortens the amount of time that the landfill 10 is required to be active. Once the landfill 10 has settled a sufficient amount, it is capped, and the land may thereafter be used for other purposes.

Injecting enriched steam into the landfill 10 can be more advantageous than injecting water for a variety of reasons. First, water expands to approximately 1,600 times its original volume upon boiling. Thus, injecting enriched steam allows total coverage of the trash prism using only a small fraction of the water that would otherwise be needed. Using less water minimizes the potential for liquid to migrate to the bottom of the landfill 10 and into the groundwater, which could cause contamination.

Second, enriched steam containing CO₂, which is a vapor, is under steam expansion pressure as well as CO₂ pressure. Thus, it requires no head pressure, as water does, to move it through the trash prism. Steam also moves naturally across temperature differentials, from hot to cold areas. Total coverage of the landfill 10 can thus be achieved with minimal work input to the system. The more effective expansion of steam also creates better moisture distribution and higher overall humidity as compared to water. Water tends to flow down to the bottom of the landfill 10 and stay there causing the lower portion of the landfill 10 to be more humid, while the upper portions, which contain the freshest refuse, remain dry. Because methane production within the landfill 10 increases with humidity, it is advantageous to maximize the humidity throughout the trash prism, rather than raising the humidity only near the bottom of the trash prism.

Third, enriched steam, as a gas, is compressible while water is not. Water thus occupies free space in the landfill 10, inhibiting settlement. As stated above, the landfill 10 desirably settles rapidly. The use of enriched steam promotes more rapid settlement of the landfill 10 than does liquid water. Airspace recovery, associated from water occupying the free space in the landfill, can make active landfills remain open for longer periods of time, delaying closure.

Fourth, enriched steam, which is at a higher temperature than liquid water under the same pressure, will tend to increase, rather than reduce, the overall temperature of the waste in the landfill 10. Decomposition proceeds best at about 100 to 120 degree F. Enriched steam can thus tend to promote better decomposition by maintaining a higher temperature within the landfill 10.

Fifth, liquids carry suspended solids and calcium carbonate, which tend to clog the gas extraction collectors 14 and bottom drains of landfills. Enriched steam does not generally carry suspended solids or calcium carbonates, and so will not lead to clogging.

To achieve these and other advantages, a first preferred method of injecting enriched steam into a landfill 10 can comprise several lines of steam injection wells 12 and several lines of gas extraction collectors 14, as in FIG. 1. The injection wells and extraction collectors 14 are preferably 2″ steel push-in screens and risers, but could be any diameter to suit a particular application, and could be constructed from sturdy materials other than steel. The collectors 14 preferably include sensors for measuring certain parameters, such as flow rates, methane concentrations, and Btu values, in order to monitor the effectiveness of the enriched steam injection method.

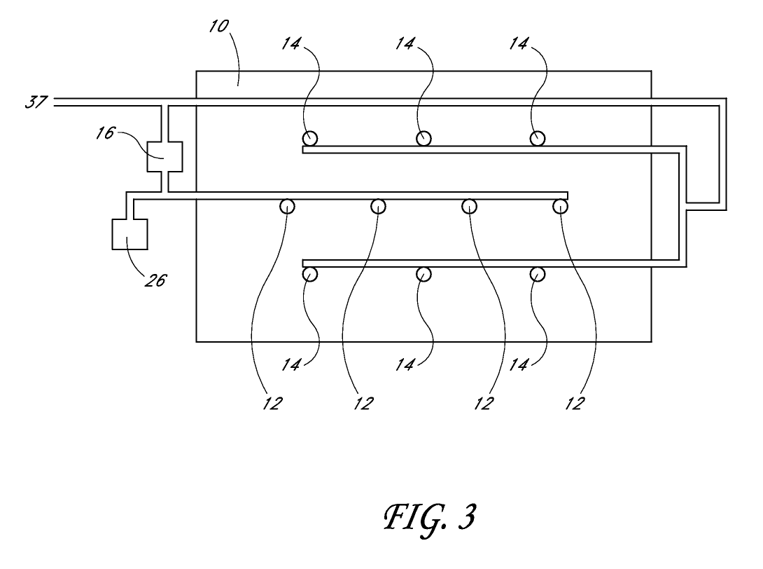

Methane can be withdrawn from the system when it is in an anaerobic phase. Steam injectors 12 can also be installed around gas collectors 14 that are already in place in the landfill 10. FIG. 3 illustrates a schematic of according to certain embodiments of a system. FIG. 3 shows a blower 26 that can force enriched steam into the landfill 10. U.S. Pat. No. 6,471,443, incorporated by reference above, provides further details concerning the anaerobic phase.

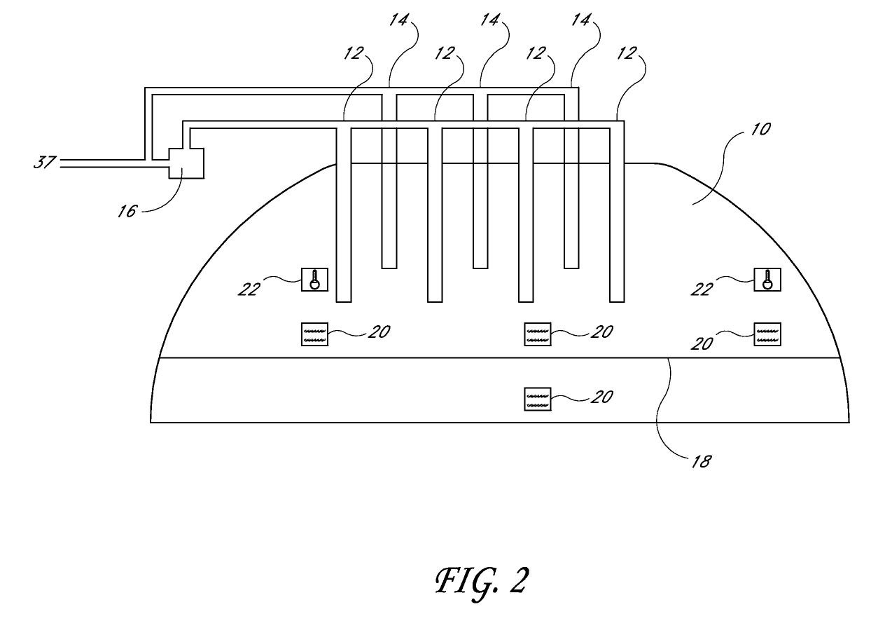

Now referring to FIG. 2, the illustrated moisture sensors 20 monitor the amount of liquid accumulating on a dense layer 18 below the injection wells 12. If liquid is detected, the amount of enriched steam injected into the landfill 10 can be reduced. The temperature sensors 22 can be used to monitor the movement of the enriched steam through the waste in a landfill or reactor. These sensors 22 can provide better monitoring of the conditions inside the landfill 10 than the moisture sensors 20. This is because the temperature sensors 22 can be used to determine not only if enriched steam is reaching the sensor 22 but also how well the enriched steam is penetrating throughout the entire system. The information that the temperature sensors 22 provide about the landfill 10 conditions can also be used to adjust the amount of enriched steam injected into the system in order to prevent liquid from accumulating on the dense layer 18, rather than adjusting the enriched steam injection after liquid is detected.

FIG. 4 shows an embodiment of a system with the use of an internal combustion (IC) engine 29. The system can be useful to flash water into steam using the heat inside an exhaust system 32 of the IC engine 29. Water can be sprayed through water jets 28 from a water supply 36 into the exhaust system 32 of the IC engine 29 to produce enriched steam. As illustrated, the enriched steam can be forced from the exhaust system 32 into a landfill, biomass reactor, etc. by a blower 26. The steam can be enriched by the gases present in the exhaust. These gases can include, for example, CO₂, CO, NOₓ and/or other gases, including exhaust gases.

In the embodiment of FIG. 5, landfill gas (LFG) can flow through a pipe 34 into a burner 31 of a flare or boiler. In the burner 31, the LFG are combusted to produce heated exhaust gases. The heated exhaust gases from combustion of the LFG can be sprayed with water from spray nozzles 28 to flash the water into steam. At the same time, the steam can mix with the exhaust gas in the sequester chamber 27 to create enriched steam. The enriched steam can then injected into the landfill via blower 26′. Some of the landfill gas may be drawn off of pipeline 34 by pipeline 37 and converted into usable fuel or for other purposes.

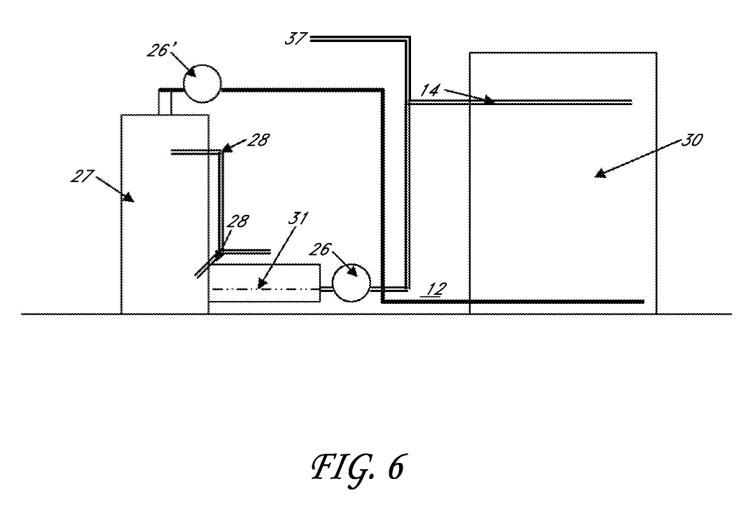

Another embodiment of the invention, shown in FIG. 6, is the injection of enriched steam into a biomass reactor 30 instead of a landfill 10. A biomass reactor 30 can be a substantially airtight vessel sized to contain any type of organic material to be converted into biogas. The conversion takes place from enriched steam which is injected into the vessel/reactor 30. The enriched steam can come from the sequester chamber 27 and is piped to the bottom, top or both of the biomass reator. If the distance from the sequester to the landfill is too great to be drawn by the collectors 14 in the landfill, then a blower 26′ can be used to boost the steam to the steam injector 12. Once the enriched steam is converted inside the landfill into landfill gas, another blower 26 is used to remove the landfill gas from the waste prism via the gas collectors 14. In some embodiments, the sequester can be used in place of a flare, though a flare may be used. The sequester can contain a burner 31 that can combust biogas/landfill gas or any combustible fuel. The exhaust from the combustion can enter the chamber 27 with spray nozzles 28, which apply the water to the exhaust. In some embodiments the exhaust is heated. When the exhaust is heated, it can flash the water into steam, sequestering the exhaust gases into the steam. In some embodiments, the water is preheated by waste heat, or otherwise, prior to being sprayed into the chamber 27 to retain more heat in the exhaust and produce hotter steam. In some embodiments, some of the biogas may be used to fire the sequester to make enriched steam to be introduced into the waste prism while the majority of the bio gas will be extracted by, for example, a pipeline 37 and used as alternative fuel and other products.

Though embodiments of the invention have been set forth above, they are susceptible to modifications and alternate constructions which are fully equivalent. Consequently, it is not the intention to limit this invention to the particular embodiments disclosed. On the contrary, the intention is to cover all modifications and alternate constructions coming within the spirit and scope of the invention.

What is claimed is:

1. A method of enhancing the decomposition of organic waste comprising;
providing steam;
enriching the steam with gas comprising at least one of CO₂, CO and NOₓ; and
injecting the enriched steam into organic material.

2. The method of claim 1, wherein the organic material is in a landfill or a biomass reactor.

3. The method of claim 1, further comprising creating steam by vaporizing water.

4. The method of claim 1, wherein the step of providing steam includes directing waste steam from a different process into the system.

5. The method of claim 1, further comprising sequestering the gas into the steam to enrich it.

6. The method of claim 3, further comprising spraying water into a chamber containing the gas and flashing the water into the steam wherein the gas is exhaust gas from a flare, boiler, turbine or internal combustion engine and the heat of the exhaust flashes the water into steam.

7. The method of claim 1, wherein the gas is exhaust gas from a flare, boiler or internal combustion engine.

8. The method of claim 1, further comprising conveying the enriched steam to the landfill or biomass reactor by negative pressure.

9. The method of claim 8, wherein the negative pressure is from the landfill or biomass reactor or from a blower.

10. The method of claim 1, wherein the gas is exhaust gas from an industrial process independent from waste treatment system.

11. A method of enhancing the decomposition of organic waste comprising:
injecting steam enriched by CO₂, CO and NOₓ into waste, the waste comprising organic refuse;
heating the waste;
monitoring conditions within the waste; and
extracting methane gas from the waste.

12. The method of claim 11, wherein the step of heating the waste comprises heating the waste with the steam.

13. The method of claim 11, wherein the waste is in a landfill or biomass reactor.

14. The method of claim 11, wherein the methane is used to create the steam.

15. A method of accelerating decomposition of organic refuse comprising:
combusting a fuel, thereby creating exhaust gas;
providing steam;
sequestering CO₂ from the exhaust gas into the steam to create enriched steam; and
injecting the enriched steam into organic refuse.

16. The method of claim 15, wherein the fuel is landfill gas from a landfill or biomass reactor.

17. The method of claim 16, wherein the landfill gas is methane.

18. The method of claim 17, wherein the methane is produced from the organic refuse which is in the landfill or biomass reactor.

19. The method of claim 15, wherein the step of combusting a fuel is performed in an internal combustion engine, flare, turbine or boiler.

20. The method of claim 15, wherein the organic refuse is in a biomass reactor.

21. The method of claim 20, wherein the fuel is produced in the biomass reactor.

22. The method of claim 15, further comprising extracting methane gas from the organic refuse.

23. The method of claim 22, wherein CO₂ is separated from the extracted methane gas to be injected into the organic refuse

24. The method of claim 15, further comprising spraying water into the exhaust gas to create the steam.

25. The method of claim 15, wherein the steam is exhaust steam from an process independent from the waste treatment process.
